(19) United States
(12) Patent Application Publication
(10) Pub. No.: US 2025/0276337 A1
(43) Pub. Date: Sep. 4, 2025

(54) JET EJECTOR ARRANGEMENT, SYSTEM AND USE THEREOF AND METHOD FOR OPERATING THE SAME

(71) Applicant: Yara International ASA, Oslo (NO)

(72) Inventors: Bernard LAURENT, Lustin (BE); Robert LAM, Woluwe Saint Pierre (BE); Tomi HUTTUNEN, Kuopio (FI); Henri PITKÄNEN, Kuopio (FI); Jakub BUJALSKI, Porsgrunn (NO)

(21) Appl. No.: 18/712,803

(22) PCT Filed: Dec. 13, 2022
(86) PCT No.: PCT/EP2022/085508

§ 371 Date: May 23, 2024

(30) Foreign Application Priority Data
Dec. 13, 2021 (EP) 21214101.4

(51) Int. Cl. B05B 7/00

(52) U.S. Cl. CPC B05B 7/0087

(57) ABSTRACT

A jet ejector arrangement, including a jet ejector with an internal nozzle having a base and a tip and, on a common longitudinal axis, an inlet for a motive fluid at the base and an outlet for the accelerated motive fluid at the tip; a hollow tube having a base and surrounding the internal nozzle, such that the base of the hollow tube surrounds the base of the nozzle, and extending downstream the tip such that the chemical components inside the hollow tube reside therein for 0.1 to 5 seconds, wherein the flow direction in the hollow tube is defined by the flow direction of the motive fluid, for mixing and reacting the motive fluid with an additional fluid feed in a reaction zone in the hollow tube, thereby providing a reacted fluid; and an opening in the wall of the hollow tube for entry of the additional fluid feed.

### FIELD

The present disclosure relates to the field of jet ejectors, their method of operation and their uses.

### BACKGROUND

Reference is made to FIG. 1 showing a conventional ejector and its basic elements. An ejector is a type of vacuum pump, which produces vacuum by means of the Venturi effect.

In an ejector, a working fluid (liquid or gaseous) (100) flows through a jet nozzle (200) into a tube (300) that expands in cross-sectional area (400). The fluid leaving the jet is flowing at a high velocity which due to Bernoulli's principle results in it having an underpressure, thus generating a vacuum. The outer tube then elongates into a mixing section (500) where the high velocity working fluid mixes with the fluid that is drawn in by the vacuum (600), imparting enough velocity for it to be ejected, the tube then typically expands to decrease the velocity of the ejected stream, allowing the pressure to smoothly increase to the external pressure.

The strength of the vacuum produced depends on the velocity and shape of the fluid jet and the shape of the constriction and mixing sections, but if a liquid is used as the working fluid the strength of the vacuum produced is limited by the vapor pressure of the liquid (for example in the case of water, 3.2 kPa or 0.46 psi or 32 mbar at 25° C. or 77° F.). If a gas is used, however, this restriction does not exist.

If not considering the source of the working fluid, vacuum ejectors can be significantly more compact than a self-powered vacuum pump of the same capacity.

### Prior Art

A pipe reactor is an example of a jet ejector. EP0272974B1 (Grande Paroisse S.A., 1993) discloses a reactor allowing an improved reaction between ammonia and acids. The improved tubular reactor incorporates a convergent-divergent member or a convergent member at the exit of the zone for introducing reactants and a convergent-divergent member or a convergent member at the exit of the reaction zone just before the exit nozzle for the finished products. As a result, the size, and hence the footprint, of the reactor is increased.

In addition, the reaction is carried out under pressure and some heat is produced by the reaction of the ammonia with the acid and vaporizes the water in the reactor itself. If the separator at the outlet of the reactor operates at atmospheric pressure, additional moisture content of the product flashes off at the discharge point of the pipe where the pressure is about 1 bara. This means that temperature within the reactor is higher than the temperature of the solution at the discharge of the pipe. Considering that, in such systems, a safety temperature is to be maintained within the reactor, the concentration of the acid in the reactor or the temperature at which the acid is fed in the reactor are to be controlled and kept sufficiently low, thereby limiting the amount of heat, and therefore energy, provided by the reaction. Said otherwise, the safety temperature required on the product imposes restrictions on the operating conditions.

Further, as the pressure inside the reactor depends on the flow rate, only within a certain operating pressure range is the temperature in the pipe reactor safe, such that the pressure range at which the reactor can be operated is limited. Moreover, as the reaction inside the reactor takes place in a confined space, in order to prevent any pressure build-up, controlling the operating pressure within a defined, safe range is critical.

GB2026611 (Koerting Aktiengesellshaft, 1980) discloses an ejector pump to pump liquid out of an enclosed space and simultaneously to maintain a vacuum within this enclosed space. A suction connection 2 for removal of gaseous media is disposed adjacent to a propellant nozzle 7 for entry of a propellant jet of liquid so that the gaseous media is drawn into a premixing tube 8, the outlet of the premixing tube 8 communicates with a mixing chamber 4 also in communication with a suction connection 9 for the liquid, whereby the liquid is drawn off at a location well downstream of the suction connection for the gaseous media. The controlling factor becomes the partial pressure created by the liquid employed for the propellant jet and this may be chosen accordingly.

The suction connection 2 is the basis of Koerting nozzles used in Koerting's liquid jet mixing nozzles and tank mixing systems. Those systems, however, are disclosed as mixing systems and involve the mixing of two components only.

One goal of this disclosure is to provide a reactive jet ejector arrangement, suitable for reacting components and also mixing those components with their products, such that an optimally complete reaction of the reactants is achieved. A further goal of this disclosure is that the reactive jet arrangement allows safe reaction of the reactants, such that the temperature and the pressure inside the jet ejector are within safe limits and remain throughout the continuous reaction of the reactants within those safe limits.

### SUMMARY

In one aspect of the disclosure, a jet ejector arrangement is disclosed. The arrangement comprises:
a jet ejector, comprising:
   an internal nozzle having a base and a tip and, on a common longitudinal axis, an inlet for a motive fluid at the base and an outlet for the accelerated motive fluid at the tip;
   a hollow tube having a base and surrounding the internal nozzle, such that the base of the hollow tube surrounds the base of the nozzle, and extending downstream the tip, in particular such that the chemical components flowing inside the hollow tube reside in the hollow tube for 0.1 to 5 seconds, wherein the flow direction in the hollow tube is defined by the flow direction of the motive fluid, for mixing and reacting the motive fluid with an additional fluid feed in a reaction zone in the hollow tube, thereby providing a reacted fluid; and
   an opening in the wall of the hollow tube for entry of the additional fluid feed.

The arrangement is characterised in that it further comprises a feed line for the additional fluid, external to the jet ejector and, when in operation, the ejector generates a suction zone outside the ejector via the opening and the output end of the feedline is located in said suction zone outside the ejector. In the jet ejector arrangement of the present disclosure, the feed output end is freely located in the vicinity of the opening, or stated differently, the output end of the feedline is spatially separated from, i.e. not connected to, the opening but is operably linked to the opening via the suction zone.

The inventors have realized that the suction in the internal nozzle can be used not only to recirculate the additional fluid, such that it is mixed with the motive fluid: it is also possible to recirculate, through the opening, all of the motive fluid not reacted in the hollow tube, the additional fluid not reacted in the hollow tube, and also any product formed by the reaction of the motive fluid with the additional fluid. For such recirculation to be possible, all that is required is to introduce the additional fluid in the feed line, having its output end in the vicinity of the opening. A key advantage of the jet arrangement of the disclosure is that, with the product being recirculated, it is possible to retain control on the temperature in the hollow tube, while improving the degree of reaction of the motive fluid and the additional fluid: said otherwise, the forced recirculation of the products of the motive fluid and the additional fluid acts as a temperature buffer. Moreover, the temperature in the reaction zone of the hollow tube also remains about constant and below the safe operational, that is around the temperature of the expanded fluid at the outlet of the jet ejector, such that there is no hot spot in the jet ejector arrangement, in particular in the reaction zone of the hollow tube.

Therefore, the jet arrangement of the disclosure is suitable for reacting components and also mixing those components with their products, such that an optimally complete reaction of the reactants is achieved. Also, the reactive jet arrangement allows safe reaction of the reactants, such that the temperature inside the jet ejector is within safe limits and remain, throughout the continuous reaction of the two reactants, within those safe limits.

In one embodiment according to the jet ejector arrangement of the disclosure, the arrangement further comprises flow control means in any one of the inlets for the motive fluid and the feed line.

In one embodiment according to the jet ejector arrangement of the disclosure, the feed line, in particular the output end of the feed line, is located from 1 to 15 cm away from the opening.

In one embodiment according to the jet arrangement of the disclosure, the jet ejector comprises two openings that are diametrically opposed in the wall of the hollow tube.

In one aspect of the disclosure, a system for reacting at least two fluid chemicals with each other is disclosed. The system comprises:
at least one jet ejector arrangement according to the arrangement of the disclosure; and
a container.

The system is characterised in that the at least one jet ejector is entirely located inside the container, the opening being in fluid communication with the content of the mixing container.

In one embodiment according to the system of the disclosure, the system comprises four jet ejector arrangements arranged, inside the container (16), symmetrically with respect to each other and tangentially with respect to the wall of the container (16).

In one embodiment according to the system of the disclosure, the system comprises multiple jet ejector arrangements located in the container and the jet ejectors arrangements are directed such that the flow direction in the jet ejectors is upwards and radially towards the center of the container.

In one embodiment according to the system of the disclosure, the container has a volume ranging from 0.5 to 20 m³.

In one embodiment according to the system of the disclosure, the system comprises:
at least two jet ejectors according to the jet ejector arrangement of the disclosure;
a recirculation line having an inlet in fluid communication with the content of the container, and an outlet in fluid communication with the content of the container; and
means for feeding part of the content of the mixing container to the recirculation line.

In one embodiment according to the system of the disclosure, the outlet of the recirculation line is in fluid communication with the inlet of the nozzle of a jet ejector, the flow direction in this jet ejector being upwards and tangential with respect to the wall of the container.

In one embodiment according to the system of the disclosure, the system further comprises temperature adjustment means in the recirculation line.

In one embodiment according to the system of the disclosure, the container comprising an outlet for its liquid content in the form of an overflow.

In one embodiment according to the system of the disclosure, the system further comprises means for recovering heat.

In one embodiment according to the system of the disclosure, the system further comprises means for separating out steam from the container and means for cleaning the separated steam.

In one aspect of the disclosure, a method for reacting two fluids in a system according to the system of the disclosure is disclosed. The method comprises the steps of:
a) feeding a first fluid as the motive fluid to the nozzle of at least one jet ejector arrangement; and
b) feeding a second fluid through the feed line of the at least one jet ejector arrangement, thereby reacting the two fluids.

In one embodiment according to the system of the disclosure, the flows of the first fluid and of the second fluid are adjusted such that the first fluid and the second fluid reside the hollow tube of the jet ejector for a period ranging from 0.1 to 5 seconds.

In one embodiment according to the method of the disclosure, the fluid fed in step a) is a gas.

In one embodiment according to the method of the disclosure, the method further comprises the step of:
c) recirculating the content of the container back to the container.

In one embodiment according to the method of the disclosure, the method is performed in a system according to a system of the disclosure comprising at least two jet ejectors and, in step c), the content of the mixing container is recirculated to the inlet of the nozzle of the at least second jet ejector.

In one embodiment according to the method of the disclosure, the method further comprises the step of:
d) operating flow control means in the inlet for the motive fluid and in the feed line of the at least one jet ejector arrangement, such as to control the ratio of the flow of the motive fluid over the flow in the feed line.

In one embodiment according to the method of the disclosure, the nozzle of the at least one jet ejector arrangement is operated at about atmospheric pressure.

In one embodiment according to the method of the disclosure, the method further comprises the step of:
e) adjusting the temperature of the content being recirculated during step c).

In one embodiment according to the method of the disclosure, the fluid fed as the motive fluid in step a) is gaseous ammonia and the fluid fed in step b) is nitric acid, such that the method produces ammonium nitrate.

In one embodiment according to the method of the disclosure, the method further comprises the step of:
f) recovering the heat generated by the combination of steps a) and b).

In one embodiment according to the method of the disclosure, the motive fluid in step a) is ammonia gas, at a temperature ranging from 50 to 200° C. and a pressure ranging from 1.5 to 13 bar, and, in step b), from 53 weight % to 63 weight % nitric acid is fed, at a temperature ranging from 20 to 100° C. and a pressure ranging from 1.5 to 3 bar

In one embodiment according to the method of the disclosure, the method is performed in a batch manner or continuously.

In one aspect of the disclosure, the use of the system for the disclosure for performing the method of the disclosure, is disclosed.

In one aspect of the disclosure, the use of the system for the disclosure for reacting an acid with a base, or as a bleacher or a stripper, or as a fertilizer slurry container, or as reactor in which emergency water can be introduced.

In one aspect of the disclosure, a method for designing a jet ejector arrangement is disclosed. The method comprises the steps of:
providing a jet ejector having an elongated body, comprising:
   an internal nozzle having a base and a tip and, on a common longitudinal axis, an inlet for a motive fluid at the base and an outlet for the motive fluid at the tip;
   a hollow tube having a base and surrounding the internal nozzle and extending downstream the tip, wherein the flow direction in the hollow tube is defined by the flow direction of the motive fluid, for mixing and reacting the motive fluid with an additional fluid feed in a reaction zone in the hollow tube, thereby providing a reacted fluid;
an opening in the wall of the hollow tube for entry of the additional fluid feed; and
a diffusor downstream the hollow tube, wherein the flow direction is aligned with the flow direction in the hollow tube, downstream the reaction zone, for expanding the reacted fluid, thereby producing an expanded reacted fluid;
   characterised in that the method comprises the step of
providing a feed line of which the feed output end is freely located in the vicinity of the opening; and
modeling the location and dimensions of the opening for entry of the additional fluid feed using a computational fluid dynamic modeling tool.

### BRIEF DESCRIPTION OF THE FIGURES

FIG. 1 shows a conventional ejector and its basic elements;

FIG. 2 shows a jet ejector arrangement according to the present disclosure;

FIG. 3 shows a jet ejector arrangement according to the present disclosure; and

FIG. 4 shows a system including a jet ejector arrangement according to the present disclosure.

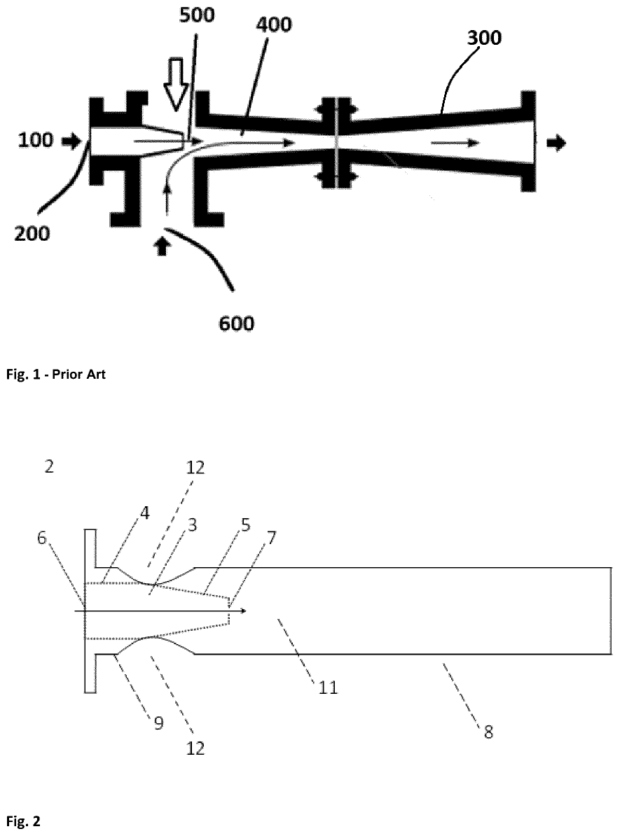

### LIST OF NUMERALS

| | |
|---|---|
| 1 | jet ejector arrangement |
| 2 | jet ejector |
| 3 | internal nozzle |
| 4 | base of the internal nozzle 3 |
| 5 | tip of the internal nozzle 3 |
| 6 | nozzle inlet for motive fluid 10 |
| 7 | outlet of internal nozzle 3 |
| 8 | hollow tube |
| 9 | base of hollow tube 8 |
| 10 | motive fluid |
| 11 | reaction zone |
| 12 | opening |
| 14 | flow direction in hollow tube 8 |
| 15 | feed line |
| 16 | container |
| 17 | recirculation line |
| 18 | inlet of recirculation line 17 or outlet of |
| | container 16 in the form of an overflow |
| 19 | outlet of recirculation line 17 |
| 20 | means for feeding (to recirculation line 17) |
| 21 | means for recovering heat |
| 22 | separated steam |
| 23 | means for cleaning the separated steam |
| 24 | ammonium nitrate |

### DETAILED DESCRIPTION

Throughout the description and claims of this specification, the words “comprise” and variations thereof mean “including but not limited to”, and they are not intended to (and do not) exclude other moieties, additives, components, integers or steps. Throughout the description and claims of this disclosure, the singular encompasses the plural unless the context otherwise requires. In particular, where the indefinite article is used, the disclosure is to be understood as contemplating plurality as well as singularity, unless the context requires otherwise.

Features, integers, characteristics, compounds, chemical moieties, or groups described in conjunction with a particular aspect, embodiment or example of the disclosure are to be understood to be applicable to any other aspect, embodiment or example described herein unless incompatible therewith. All of the features disclosed in this disclosure (including the description, claims, abstract and drawing), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this disclosure (including the description, claims, abstract and drawing), or to any novel one, or any novel combination, of the steps of any method or process so disclosed.

The enumeration of numeric values by means of ranges of figures comprises all values and fractions in these ranges, as well as the cited end points. The terms “in the ranges of” and “ranging from . . . to . . . ” as used when referring to a range for a measurable value, such as a parameter, an amount, a time period, and the like, is intended to include the limits associated to the range that is disclosed.

As defined herein, “about” means . . . Where the term “about” is applied to a particular value (e.g. “about 180° C.”), the value is interpreted as being as accurate as the method used to measure it.

As defined herein, a fluid is a liquid or a gas. As defined herein, an acid is a substance having a pKa value or a pH value below 7. As defined herein, a base is a substance having a pKa value or a pH value above 7.

### Arrangement of the Disclosure

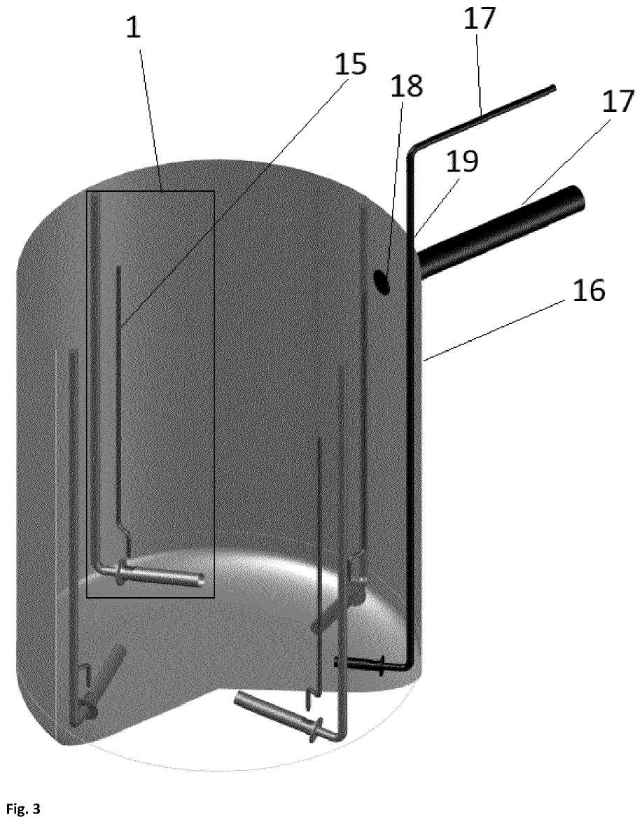

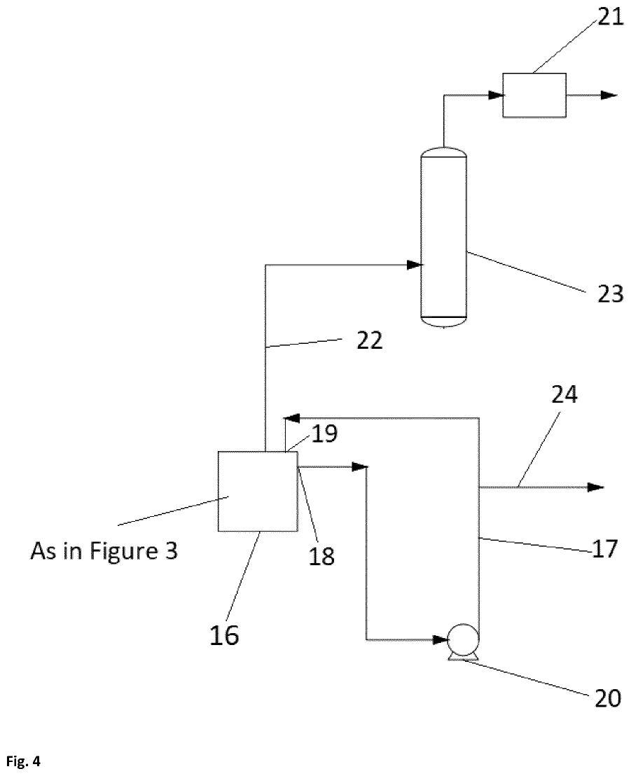

Reference is made to FIGS. 2 and 3. In one aspect of the disclosure, a jet ejector arrangement 1 is disclosed. The arrangement 1 comprises a jet ejector 2, comprising an internal nozzle 3 having a base 4 and a tip 5 and, on a common longitudinal axis, an inlet 6 for a motive fluid 10 at the base 4 and an outlet 7 for the accelerated motive fluid at the tip 5; a hollow tube 8 having a base 9 and surrounding the internal nozzle 3, such that the base 9 of the hollow tube 8 surrounds the base 4 of the nozzle 3, and extending downstream the tip 5, in particular such that the chemical components flowing inside the hollow tube 8 reside in the hollow tube 8 for 0.1 to 5 seconds, wherein the flow direction in the hollow tube 8 is defined by the flow direction of the motive fluid 10, for mixing and reacting the motive fluid 10 with an additional fluid feed in a reaction zone 11 in the hollow tube 8, thereby providing a reacted fluid; and an opening 12 in the wall of the hollow tube 8 for entry of the additional fluid feed.

The arrangement is characterised in that it further comprises a feed line 15 for the additional fluid, external to the jet ejector, of which the feed output end is freely located in the vicinity of the opening 12. More in particular, when in operation, the ejector generates a suction zone outside the ejector via the opening and the output end of the feedline is located in said suction zone outside the ejector.

The motive fluid 10 is delivered into the internal nozzle 3 at a defined pressure. The flow section in the nozzle is reduced causing pressure drop and a velocity increase for the motive fluid 10 at the outlet 7 of the nozzle 10. The conversion of the static pressure of the motive fluid 10 into velocity generates a corresponding negative pressure at the opening 12 which generates a suction flow. The kinetic energy from the motive fluid is transferred to this suction flow. All that is required for this suction flow to be present is that the motive fluid 10 is introduced at the temperature and pressure required to achieve the motive force, typically from 1.5 to 13 bar and from 50 to 200° C.

The inventors have realized that the suction in the internal nozzle 3 can be used not only to recirculate the additional fluid, such that it is mixed with the motive fluid 10: it is also possible to recirculate, through the opening 12, all of the motive fluid 10 not reacted in the hollow tube 8, the additional fluid not reacted in the hollow tube 8, and also any product formed by the reaction of the motive fluid 10 with the additional fluid. For such recirculation to be possible, all that is required is to introduce the additional fluid in the feed line 15, having its output end in the vicinity of the opening 12. A key advantage of the jet arrangement 1 of the disclosure is that, with the product being recirculated, it is possible to retain control on the temperature in the hollow tube 8, while improving the degree of reaction of the motive fluid 10 and the additional fluid: said otherwise, the forced recirculation of the products of the motive fluid 10 and the additional fluid acts as a temperature buffer. Moreover, the temperature in the reaction zone 11 of the hollow tube 8 also remains about constant, that is around the temperature of the expanded fluid at the outlet of the diffusor 13, such that there is no hot spot in the jet ejector arrangement 1, in particular in the reaction zone 11 of the hollow tube 8.

Therefore, the jet arrangement of the disclosure is suitable for reacting components and also mixing those components with their products, such that an optimally complete reaction of the reactants is achieved. Also, the reactive jet arrangement 1 allows safe reaction of the reactants, such that the temperature inside the jet ejector 2 is within safe limits and remain, throughout the continuous reaction of the two reactants, within those safe limits.

In particular, the outlet 7 for the accelerated motive fluid at the tip 5 of the nozzle 3 extends beyond the opening 12, that is beyond the point of the opening 12 further away from the base 9 of the hollow tube 8. In this manner, any by-pass of the motive fluid 10 through the opening 12 is minimized and entry of any fluid external to the hollow tube 8 inside the hollow tube 8 is maximized. As a result, mixing and reaction in the reaction zone 11 are further improved and proceed faster.

In particular, the ratio of the length L of the hollow tube 8 in the downstream direction, behind the tip 5, over the diameter D of the hollow tube 8 ranges from 4 to 7. At such ratio, the insertion of the jet ejector arrangement 1 in a tank results in optimal fluid dynamics, such the inserted jet ejector arrangement 1 optimally performs the above described functions.

In one embodiment according to the jet ejector arrangement 1 of the disclosure, the arrangement 1 further comprises flow control means in any one of the inlets for the motive fluid 10 and the feed line 15.

By controlling the flows of the motive fluid 10 and the feed line 15 can, not only the temperature and pressure conditions in the reaction zone 11 of the hollow tube 8 be controlled, but also the stoichiometric ratio of the motive fluid 10 and the additional fluid. In addition, through controlling the pressure of the motive fluid 10, it is possible to control the suction at the opening, thereby controlling the extent, that is the number of time, all of the motive fluid 10 not reacted in the hollow tube 8, the additional fluid not reacted in the hollow tube 8, and also any product formed by the reaction of the motive fluid 10 with the additional fluid, are recirculated to the jet arrangement 1.

In one embodiment according to the jet ejector arrangement 1 of the disclosure, the feed line 15 is located from 1 to 15 cm away from the opening 12.

When the feed line 15 is positioned in such a way with respect the opening 12 of the hollow tube 8, the suction at the opening 12 is maximized, such that the recirculation of the motive fluid 10 not reacted in the hollow tube 8, the additional fluid not reacted in the hollow tube 8, and also any product formed by the reaction of the motive fluid 10 with the additional fluid is maximized, thereby maximizing the reaction yield and the temperature buffer effect in the reaction zone 11 of the hollow tube 8. The person skilled in the art may optimize the jet ejector arrangement 1 with no difficulty by introducing multiple feed lines 15 for the additional fluid in the vicinity of the opening 12, such that the suction at the opening 12 is optimized. Similarly, the person skilled in the art may also, without any technical difficulty, introduce a shell around the opening 12, to optimize the suction at this opening.

In one embodiment according to the jet ejector arrangement 1 of the disclosure, the jet ejector 2 comprises two openings 12 diametrically opposed in the wall of the hollow tube 8.

In the presence of two openings 12, the suction at the hollow tube 8 is increased, thus increasing the recirculation of the motive fluid 10, the additional fluid and their products in the hollow tube 8. Thereby, the reaction of the motive fluid 10 with the additional fluid is improved: it proceeds faster and its yield is increased. Further, and of importance, is the fact that the openings 12 prevent the reaction zone 11 in the hollow tube 8 from being a closed space, such as is the case in the pipe reactor. Hence, the system of the disclosure prevents pressure build-up and provides additional safety.

### System of the Disclosure

In one aspect of the disclosure, a system for reacting at least two fluid chemicals with each other is disclosed. The system comprises:
at least one jet ejector arrangement 1 according to the arrangement 1 of the disclosure; and
a container 16.

The system is characterised in that the at least one jet ejector 2 is entirely located inside the container 16, the opening 12 being in fluid communication with the content of the mixing container 16.

When a jet ejector arrangement 1 is arranged entirely inside a container 16, the content of the container is recirculated in the jet ejector arrangement 1, resulting in the benefits mentioned above, namely a safer and more complete reaction of the reactants introduced in the container 16, through the nozzle 2 and the feed line 15 of the jet ejector arrangement 1. The jet ejector 2 can also be located outside the container 16. The jet ejector 2 can also be partially inside the container 16, such that at least the outlet 7 of the nozzle 3, the opening 12, the reaction zone 11 of the hollow tube 8 and the feed line 15 are inside the container 16. In this manner, it is not necessary to have piping connecting the opening 12 to the container 16. It is nonetheless possible to have the jet ejector 2 located outside the container 16, in which case it is necessary to have piping connecting the opening 12 to the container 16. The location of the jet ejector 2 outside the container 16 can be beneficial in the case the reaction of the motive fluid 10 and the additional results in the formation of solids clogging the jet ejector 2: when the jet ejector 2 is located outside the container 16, it can be more easily maintained and, in the presence of multiple jet ejector arrangements 1 in the system, it is not necessary to shut-down the system and thereby stop the production processes as only the clogged jet ejectors 2 can be separated from the system and maintained, while production proceeds through other jet ejector arrangements 1 in the system.

In one embodiment according to the system of the disclosure, the system comprises four jet ejector arrangements 1 arranged, inside the container 16, symmetrically with respect to each other and tangentially with respect to the wall of the container 16.

An advantage of the present system is its flexibility: it is possible to perform the reaction of the motive fluid 10 with the additional fluid in a system using a single jet ejector arrangement 1 of the appropriate size and volume. It is also possible to perform the reaction of the motive fluid 10 with the additional fluid using multiple single jet ejector arrangement 1, each of a smaller size and volume than the jet ejector arrangement 1 in the system with a jet ejector arrangement 1. It has been found that using four jet ejector arrangements 1 arranged, inside the container 16, symmetrically with respect to each other and tangentially with respect to the wall of the container 16, provides an optimal recirculation to the opening 12 of the jet ejector 2, and thereby an optimal reaction of the motive fluid 10 with the additional fluid. The presence of multiple jet ejector arrangements 1 has a positive impact on the turndown ratio for the process: it is possible to reduce the production volume by operating only one or some of, and not all the multiple jet ejector arrangements 1.

In one embodiment according to the system of the disclosure, the system comprises multiple jet ejector arrangements 1 located in the container 16 and the jet ejectors arrangements 1 are directed such that the flow direction in the jet ejectors 2 is upwards and radially towards the center of the container 16.

When the flow in multiple jet ejectors 2 is upwards and radially towards the center of the container 16, a maximum of the fluid inside the container 16 is recirculated to the openings 12 of the jet ejectors 2. Thereby, a more complete reaction of the motive fluid 10 with the additional fluid is achieved. In turn this means less unreacted products, hence increased yield of the reaction and higher purity of the products upon their separation. Alternatively, a system with an arrangement of jet ejector arrangements 1 in series can provide optimal recirculation of a maximum volume of the fluid in the container 16.

In one embodiment according to the system of the disclosure, the container 16 has a volume ranging from 0.5 to 20 m³.

As has been discussed above, due to the suction flow to the opening 12 of the jet ejector arrangement 1, the reaction of the motive fluid 10 with the additional fluid is improved. Consequently, the size and volume of the jet ejector 2 can be minimized. Hence, less volume of the container 16 has to be accounted for recycling to the opening of the jet ejectors 2 when they are located inside the container 16. Furthermore, due to the efficient recirculation to the opening 12, a large hold-up volume in the container 16 is not necessary to ensure temperature control in the mixing zone 11 of the hollow tube 8. This means that the volume of the container 16 can be minimized when a jet ejector arrangement 1 according to the disclosure is used. Consequently, the system of the disclosure offers the advantage of a reduced footprint.

Reference is made to FIG. 4. In one embodiment according to the system of the disclosure, the system comprises:
at least two jet ejectors 2 according to the jet ejector arrangement 1 of the disclosure;
a recirculation line 17 having an inlet 18 in fluid communication with the content of the container, and an outlet 19 in fluid communication with the content of the container 16; and
means for feeding 20 part of the content of the mixing container 16 to the recirculation line 17.

Dead zones in the container 16 are typically minimized by placing an active mixing device, such as an agitator, and by having a continuous recirculation flow inside the container 16, through the means 20. Typically, the means 20 are a pump, downstream the tank reactor, in order to supply the content of the container 16 according to the demand. In order to prevent their damage, it is however standard practice to maintain a continuous flow to the means 20, even when the content of the container 16 no longer has to be supplied downstream, through a so-called a spill-back line, the recirculation line 17, usually to the top of the container 16 or through a so-called dip pipe. Hence, the recirculation line 17 not only preserved the means 20, it also ensures mixing in the container 16.

Further, it is possible that an additional jet ejector 2 is used as the active device minimizing, and even eliminating the dead zones inside the container 16. As long as a motive fluid 10 is forced through the nozzle 3 of the additional jet ejector 2, a suction at the opening of the additional jet ejector 2 results in the mixing of the fluid in the container 16, thereby minimizing and even eliminating the dead zones inside the container 16.

In one embodiment according to the system of the disclosure, the outlet 19 of the recirculation line 17 is in fluid communication with the inlet of the nozzle of a jet ejector 2, the flow direction in this jet ejector 2 being upwards and tangential with respect to the wall of the container 16.

In the case a recirculation line 17 and an additional jet ejector 2 are used, the motive fluid 10 in the nozzle 3 of the additional jet ejector 2 can be the fluid from the outlet 19 of the recirculation line 17. The mixing effect of the recirculation line 17, combined with the suction effect at the opening 12 of the nozzle 3 of the additional jet ejector 2, provides an optimal mixing and reaction of the fluids in the container 16. When the flow direction in the jet ejector 2 is downwards and parallel to the bottom of the container 16, the fluids in container 16 are optimally mixed and reacted. Alternatively, the motive flow 10 from the outlet 19 of the recirculation 17, in the additional jet ejector 2, can be directed to the bottom of the container 16, the additional jet ejector 2 being located at the center of the container 16.

In one embodiment according to the system of the disclosure, the system further comprises temperature adjustment means in the recirculation line 17.

In the presence of such temperature adjustment means, the temperature of the fluid recirculated to the container is controlled, such that, in turn, the temperature of the liquid inside the container 16, and thereby inside the jet ejector 2 to which the fluids inside the container 16 are recirculated through the opening 12 of the jet ejector 2, is also controlled. This offers additional safety and reaction control.

In one embodiment according to the system of the disclosure, the container 16 comprising an outlet 18 for its liquid content in the form of an overflow.

The outlet 18 of the container can correspond to the inlet 18 of the recirculation line 17. It is preferred that the fluids in the container 16, once they have been sufficiently reacted through the jet ejector 2, that is after the motive fluid 10 and the additional fluid have been recirculated a sufficient number of times in the jet ejector 2 through the opening 12 of the ejector 2 such that the fluids in the container 16 contain the desired percentage of the liquid product formed by the reaction of the motive fluid 10 and the additional fluid, leave the container 16 in the form of an overflow. In this manner, no additional power, such as the power required to power a pump, is required to extract the fluids from the container 16.

In one embodiment according to the system of the disclosure, the system further comprises means for recovering heat 21.

In the case that the reaction of the motive fluid 10 with the additional fluid is an exothermic reaction and produces heat, it is desirable to recover this heat for the purpose of recovering the energy provided by the reaction. The system of the disclosure allows for the integration of such means for recovering heat.

In one embodiment according to the system of the disclosure, the system further comprises means for separating out steam from the container and means for cleaning the separated steam 23.

Along with means for recovering heat, the system of the disclosure can further comprise means for separating out steam (not shown), such as a steam separator or a demister which can be located inside the container (16). In addition, the system can also comprise means for cleaning the separated steam 23, such as a washing column. In a pipe reactor, the amount of aerosols and droplets of the product leaving the container 16 with the steam depends on the production rate. Advantageously, due to the suction effect resulting in the recirculation to the opening 12 of the jet ejector 2, the system of the disclosure offers better steam separation from the fluids in the container 16, that is a better separation of gases from liquids, than a system comprising a pipe reactor. Advantageously as well, in the present system, due to the stability of the temperature inside the mixing zone 11 of the hollow tube 8, the fluids in the container 16 act as an internal buffer, such that the steam leaving the container 16 requires less separation, in the means for separating out steam 22 such as a steam separator, from droplets of the fluids in the container 16. Also, the steam leaving the container 16 requires less cleaning, in the means for cleaning 23 such as a washing column, from vapours of the fluids in the container 16.

### Method of the Disclosure

Reference is made to FIGS. 2 and 3. In one aspect of the disclosure, a method for reacting two fluids in a system according to the system of the disclosure is disclosed. The method comprises the steps of:
a) feeding a first fluid as the motive fluid to the nozzle 3 of at least one jet ejector arrangement 1; and
b) feeding a second fluid through the feed line 15 of the at least one jet ejector arrangement 1, thereby reacting the two fluids.

The motive fluid 10 is delivered into the internal nozzle 3 at a defined pressure. The flow section in the nozzle is reduced causing pressure drop and a velocity increase for the motive fluid 10 at the outlet 7 of the nozzle 10. The conversion of the static pressure of the motive fluid 10 into velocity generates a corresponding negative pressure at the opening 12 which generates a suction flow. The kinetic energy from the motive fluid is transferred to this suction flow. All that is required for this suction flow to be present is that the motive fluid 10 is introduced at the pressure required to achieve the motive force, typically from 3 to 6 bar.

The inventors have realized that the suction in the internal nozzle 3 can be used not only to recirculate the additional fluid, such that it is mixed with the motive fluid 10: it is also possible to recirculate, through the opening 12, all of the motive fluid 10 not reacted in the hollow tube 8, the additional fluid not reacted in the hollow tube 8, and also any product formed by the reaction of the motive fluid 10 with the additional fluid. For such recirculation to be possible, all that is required is to introduce the additional fluid in the feed line 15, having its output end in the vicinity of the opening 12. A key advantage of the jet arrangement 1 of the disclosure is that, with the product being recirculated, it is possible to retain control on the temperature and pressure in the hollow tube 8, while improving the degree of reaction of the motive fluid 10 and the additional fluid: said otherwise, the forced recirculation of the products of the motive fluid 10 and the additional fluid acts as a temperature buffer. Moreover, the temperature in the reaction zone 11 of the hollow tube 8 also remains about constant, that is about the temperature of the expanded fluid at the outlet of the diffusor 13, such that there is no hot spot in the jet ejector arrangement 1, in particular in the reaction zone 11 of the hollow tube 8.

Therefore, the jet arrangement of the disclosure is suitable for reacting components and also mixing those components with their products, such that an optimally complete reaction of the reactants is achieved. Also the reactive jet arrangement 1 allows safe reaction of the reactants, such that the temperature and the pressure inside the jet ejector 2 are within safe limits and remain, throughout the continuous reaction of the reactants, within those safe limits.

In one embodiment according to the method of the disclosure, the flows of the first fluid and of the second fluid are adjusted, such that the first fluid and the second fluid reside inside the hollow tube 8 of the jet ejector 2 for 0.1 to 5 seconds. It has been found that this period of time is optimal for reacting the first fluid and the second fluid.

The person skilled in the art will without difficulty perform this flow adjustment. Furthermore, he/she will perform this adjustment in the light of the dimensions of the hollow tube 8. In particular and for conveniency, he may, as described above, employ a jet ejector arrangement 1 in which the ratio of the length L of the hollow tube 8 in the downstream direction, behind the tip 5, over the diameter D of the hollow tube 8 ranges from 4 to 7. As mentioned above, at such ratio, the insertion of the jet ejector arrangement 1 in a tank results in optimal fluid dynamics, such the inserted jet ejector arrangement 1 optimally performs the above described functions.

In one embodiment according to the method of the disclosure, the fluid fed in step a) is a gas. It is particularly advantageous to use a gas as the motive fluid 10, as the velocity of the gas at the outlet 7 of the nozzle 3 is further expanded compared to when the motive fluid 10. Consequently, the velocity of the motive fluid 10 at the outlet 7 of the nozzle 3 is further increased compared to when the motive fluid 10. As a result, the suction flow to the opening 12 of the jet ejector 2 is increased. Thereby, the mixing and the reacting of the motive fluid 10 and of the additional fluid are increased and improved.

Reference is made to FIG. 4. In one embodiment according to the method of the disclosure, the method further comprises the step of:
c) recirculating the content of the container 16 back to the container 16.

Dead zones in the container 16 are typically minimized by placing an active mixing device, such as an agitator, and by having a continuous recirculation flow inside the container 16, through the means 20. Typically, the means 20 are a pump, downstream the tank reactor, in order to supply the content of the container 16 according to the demand. In order to prevent their damage, it is however standard practice to maintain a continuous flow to the means 20, even when the content of the container 16 no longer has to be supplied downstream, through a so-called a spill-back line, the recirculation line 17, usually to the top of the container 16 or through a so-called dip pipe. Hence, the recirculation line 17 not only preserved the means 20, it also ensures mixing in the container 16.

Further, it is possible that an additional jet ejector 2 is used as the active device minimizing, and even eliminating the dead zones inside the container 16. As long as a motive fluid 10 is forced through the nozzle 3 of the additional jet ejector 2, a suction at the opening of the additional jet ejector 2 results in the mixing of the fluid in the container 16, thereby minimizing and even eliminating the dead zones inside the container 16.

In one embodiment according to the method of the disclosure, the method is performed in a system according to a system of the disclosure comprising at least two jet ejectors 2 and, in step c), the content of the mixing container 16 is recirculated to the inlet of the nozzle 3 of the at least second jet ejector 2.

In the case a recirculation line 17 and an additional jet ejector 2 are used, the motive fluid 10 in the nozzle 3 of the additional jet ejector 2 can be the fluid from the outlet 19 of the recirculation line 17. The mixing effect of the recirculation line 17, combined with the suction effect at the opening 12 of the nozzle 3 of the additional jet ejector 2, provides an optimal mixing and reaction of the fluids in the container 16.

In one embodiment according to the method of the disclosure, the method further comprises the step of:
d) operating flow control means in the inlet (6) for the motive fluid (10) and in the feed line (15) of the at least one jet ejector arrangement (1), such as to control the ratio of the flow of the motive fluid (10) over the flow in the feed line (15).

By controlling the flows of the motive fluid 10 and the feed line 15 can, not only the temperature and pressure conditions in the reaction zone 11 of the hollow tube 8 be controlled, but also the stoichiometric ratio of the motive fluid 10 and the additional fluid. In addition, through controlling the pressure of the motive fluid 10, it is possible to control the suction at the opening, thereby controlling the extent, that is the number of time, all of the motive fluid 10 not reacted in the hollow tube 8, the additional fluid not reacted in the hollow tube 8, and also any product formed by the reaction of the motive fluid 10 with the additional fluid, are recirculated to the jet arrangement 1.

In one embodiment according to the method of the disclosure, the nozzle 3 of the at least one jet ejector arrangement 1 is operated at atmospheric pressure.

By operating the nozzle 3 of the at least one ejector 2 at atmospheric pressure, high temperature points or high pressure points in the hollow tube 8 of the at least one ejector 2 are further prevented. Said otherwise, the operating pressure is a measure, added to that of the system of the disclosure itself ensuring stability of the pressure and temperature in the hollow tube 8 of the at least one ejector 2, for safely operating the system of the disclosure.

In one embodiment according to the method of the disclosure, the method further comprises the step of:
e) adjusting the temperature of the content being recirculated during step c).

In the presence of such temperature adjustment means, the temperature of the fluid recirculated to the container is controlled, such that, in turn, the temperature of the liquid inside the container 16, and thereby inside the jet ejector 2 to which the fluids inside the container 16 are recirculated through the opening 12 of the jet ejector 2, is also controlled. This offers additional safety and reaction control.

In one embodiment according to the method of the disclosure, the fluid fed as the motive fluid 10 in step a) is gaseous ammonia and the fluid fed in step b) is nitric acid, such that the method produces ammonium nitrate.

The production of ammonium nitrate involves the reaction as ammonia gas. As explained above, when ammonia gas is the motive fluid 10, the suction flow to the opening 12 of the jet ejector 2 is increased. Thereby, the mixing and the reacting of ammonia gas and nitric acid are increased and improved. Also, not only is the temperature controlled through the recirculation through the opening 12: also the pH is controlled such that the reaction between ammonia and nitric acid is optimized.

In addition and also as explained above, due to the possibility to operate the nozzle 3 of the at least one ejector 2 at atmospheric pressure, and due to the stability of the temperature and the pressure in the hollow tube 8 of the at least one ejector 2, it has been found that it is possible to safely produce a 80 to 95 weight % ammonium nitrate solution, operating at atmospheric pressure: without any power required to pressurize the motive flow 10, and without any high temperature or pressure point in the hollow tube 8, it is possible to produce an ammonium nitrate solution that does not require a subsequent evaporation step in order to produce ammonium nitrate of a commercial grade.

Moreover, even upon using an acid as the additional fluid, due to good reaction and homogenization in the hollow tube 8, corrosion of the components of the at least one ejector 2 are prevented, hence the lifetime of the system is improved and the process can be practiced for a longer period time, without the at least one ejector 2 having to be maintained or replaced.

In one embodiment according to the method of the disclosure, the method further comprises the step of:
f) recovering the heat generated by the combination of steps a) and b).

In the case that the reaction of the motive fluid 10 with the additional fluid is an exothermic reaction and produces heat, it is desirable to recover this heat for the purpose of recovering the energy provided by the reaction. The system of the disclosure allows for the integration of such means for recovering heat. For example, the heat generated in the production of ammonium nitrate can be recovered.

As particular means for recovering heat, the system of the disclosure can further comprise means for separating out steam 22, such as a steam separator. In addition, the system can also comprise means for cleaning the separated steam 23, such as a washing column. In a pipe reactor, the amount of aerosols and droplets of the product leaving the container 16 with the steam depends on the production rate. Advantageously, due to the suction effect resulting in the recirculation to the opening 12 of the jet ejector 2, the system of the disclosure offers better steam separation from the fluids in the container 16, that is a better separation of gases from liquids, than a system comprising a pipe reactor. Advantageously as well, in the present system, due to the stability of the temperature inside the mixing zone 11 of the hollow tube 8, the fluids in the container 16 act as an internal buffer, such that the steam leaving the container 16 requires less separation, in the means for separating out steam 22 such as a steam separator, from droplets of the fluids in the container 16. Also, the steam leaving the container 16 requires less cleaning, in the means for cleaning 23 such as a washing column, from vapours of the fluids in the container 16.

In one embodiment according to the method of the disclosure, the motive fluid 10 in step a) is ammonia gas, at a temperature ranging from 50 to 200° C. and a pressure ranging from 1.5 to 13 bar, and, in step b), from 53 weight % to 63 weight % nitric acid is fed, at a temperature ranging from 20 to 100° C. and a pressure ranging from 1.5 to 3 bar.

Under those conditions, a 92 to 99 weight % ammonium nitrate solution can be produced and requires no subsequent evaporation step. The temperature inside the system is kept at safe levels, that is below or at about 180° C., at all times during the reaction. Furthermore, the power consumption associated to pressurizing and heating the reactants is minimized. Also, not only is the power consumption for practicing the process reduced, heat is also produced and can be, as described above, recovered.

### Uses of the System of the Disclosure

In one embodiment according to the method of the disclosure, the method is performed in a batch manner or continuously.

In one aspect of the disclosure, the use of the system for the disclosure for performing the method of the disclosure, is disclosed.

In one aspect of the disclosure, the use of the system for the disclosure for reacting an acid with a base, or as a bleacher or a stripper, or as a fertilizer slurry container, or as reactor in which emergency water can be introduced, is disclosed.

The reaction of an acid with a base is known as a neutralization reaction and is known to produce heat. It is essential that that the acid and the base are sufficiently brought into contact with each other to be fully reacted. It is further important to retain control on the temperature of the neutralization reaction and to have the appropriate elements in the system for recovering heat. As the system of the disclosure allows for all optimal reaction, under temperature-controlled conditions and also to recover the steam produced by an exothermic reaction, the system of the disclosure is especially suitable for reacting and acid with a base. In particular, the acid is nitric acid, sulfuric acid, phosphoric acid, hydrofluoric acid, hexafluorosilicic acid, metasilicilic acid or a mixture thereof. In particular, the base is ammonia, more in particular, ammonia gas, sodium hydroxide, potassium hydroxide, calcium hydroxide, magnesium carbonate, sodium carbonate and sodium bicarbonate.

A bleaching or a stripping system involves both a bleaching or a gaseous stripping medium respectively and a liquid medium to be bleached or stripped respectively. For the bleaching or stripping to be efficient, the gaseous bleaching or stripping medium must be effectively mixed with the liquid medium to be bleached or stripped. Therefore, the gaseous bleaching or stripping medium can be introduced in the system of the disclosure as the motive fluid 10 and the liquid medium to be bleached can be introduced in the system of the disclosure as the additional fluid through the feed line 15. The production of fertilizer slurries also involves the mixing and reaction of salt solutions such as ammonium salts suspensions or solutions and urea suspensions or solutions. In particular one of the salt solutions to be mixed and reacted is ammonium nitrate, ammonium sulphate, mono ammonium phosphate diammonium phosphate or a mixture thereof. To note is that the ammonium salt solution can be produced in a first stage from the reaction of an acid with a base, as described above, and subsequently further reacted with another component, such as urea in a urea solution. Temperature, pressure and pH control in the production of such fertilizer slurries is critical. Therefore, the system of the disclosure is especially suitable for use in the production of fertilizer slurries.

Also, as the mixing of water in emergency situations is critical in maintaining safety, the system of the disclosure is particularly suited. Typically, when water is introduced in a medium for the purpose of cooling and maintaining temperature, if introduced at the top of the medium requiring cooling the mixing may not be sufficient to achieve the target safety temperature range. Deep pipes have tried to remediate to this issue by enabling water to be flown to the bottom of a container, the temperature inside which requires to be lowered. However, also upon using deep pipes, this has been observed that water tends to settle at the bottom of the container and does not properly mix with the content in the upper part of the container. The system of the disclosure having the potential to both recirculate the entire content of the container 16 to the opening 12 of the jet ejector 2, and to mix the motive fluid 10 and the additional fluid inside the jet ejector 2, the efficient mixing of water of an entire defined volume requiring cooling, can be achieved with the system of the disclosure. Therefore, the system of the disclosure provides additional safety potential.

### Method for Designing a Jet Ejector Arrangement

In one aspect of the disclosure, a method for designing a jet ejector arrangement 1 is disclosed. The method comprises the steps of:
providing a jet ejector 2 having an elongated body, comprising:
   an internal nozzle 3 having a base 4 and a tip 5 and, on a common longitudinal axis, an inlet 6 for a motive fluid 10 at the base 4 and an outlet 7 for the motive fluid at the tip 5;
   a hollow tube 8 having a base 9 and surrounding the internal nozzle 3 and extending downstream the tip 5, wherein the flow direction in the hollow tube 8 is defined by the flow direction of the motive fluid 10, for mixing and reacting the motive fluid 10 with an additional fluid feed in a reaction zone 11 in the hollow tube 8, thereby providing a reacted fluid;
an opening 12 in the wall of the hollow tube 8 for entry of the additional fluid feed; and
a diffusor 13 downstream the hollow tube, wherein the flow direction is aligned with the flow direction 14 in the hollow tube 8, downstream the reaction zone 11, for expanding the reacted fluid, thereby producing an expanded reacted fluid;
   characterised in that the method comprises the step of
providing a feed line 15 of which the feed output end is freely located in the vicinity of the opening 12; and
modeling the location and dimensions of the opening for entry of the additional fluid feed using a computational fluid dynamic modeling tool.

As described above, the inventors have realized that the suction in the internal nozzle 3 can be used not only to recirculate the additional fluid, such that it is mixed with the motive fluid 10: it is also possible to recirculate, through the opening 12, all of the motive fluid 10 not reacted in the hollow tube 8, the additional fluid not reacted in the hollow tube 8, and also any product formed by the reaction of the motive fluid 10 with the additional fluid. For such recirculation to be possible, all that is required is to introduce the additional fluid in the feed line 15, having its output end in the vicinity of the opening 12.

The inventors have further realized that it is possible to determine the optimal dimensions and location in the hollow tube (8) and with respect to the internal nozzle (3) through computational fluid modeling (CFD): by simulating through CFD the design of the jet ejector arrangement (1) and the mixing and the reaction of the motive fluid (10) with the additional fluid in the jet ejector arrangement (1), it is possible to determine the optimal dimensions and location in the hollow tube (8) and with respect to the internal nozzle (3), in order for the mixing and the reaction of the motive fluid (10) with the additional fluid in the jet ejector arrangement (1) to be optimal.

### EXAMPLE

Reference is made to FIGS. 2 to 4. A system was provided which comprised a jet ejector arrangement (1), comprising a jet ejector (2), comprising an internal nozzle (3) having a base (4) and a tip (5) and, on a common longitudinal axis, an inlet (6) for a motive fluid (10) at the base (4) and an outlet (7) for the accelerated motive fluid at the tip (5); a hollow tube (8) having a base (9) and surrounding the internal nozzle (3), such that the base (9) of the hollow tube (8) surrounded the base (4) of the nozzle (3), and extended downstream the tip (5) such that the components inside the hollow tube (8) resided in the hollow tube (8) for 0.1 to 5 seconds, wherein the flow direction in the hollow tube (8) was defined by the flow direction of the motive fluid (10), for mixing and reacting the motive fluid (10) with an additional fluid feed in a reaction zone (11) in the hollow tube (8), thereby providing a reacted fluid; an opening (12) in the wall of the hollow tube (8) for entry of the additional fluid feed; a diffusor (13) downstream the hollow tube, wherein the flow direction was aligned with the flow direction (14) in the hollow tube (8), downstream the reaction zone (11), for expanding the reacted fluid, thereby producing an expanded reacted fluid; a feed line (15) for the additional fluid, of which the feed output end is freely located in the vicinity of the opening (12); and a container (16). The outlet (7) of the tip (5) of the nozzle (3) was located downstream to the opening (12). Ammonia gas was fed as the motive fluid (10) at a temperature ranging from 50 to 200° C. and a pressure ranging from 1.5 to 13 bar, and from 53 weight % to 63 weight % nitric acid was fed as the additional fluid, at a temperature ranging from 20 to 100° C. and a pressure ranging from 1.5 to 3 bar. The temperature in the hollow tube (8) was controlled to about 180° C. during the reaction of ammonia and nitric acid. A 92 weight % solution of ammonium nitrate was obtained (24). Furthermore, the steam (22) from the container (16) naturally disengaged from the container (16). Upon collecting and analyzing the steam it was found that no separator for separating droplets of ammonium nitrate was necessary to treat the steam disengaged from the container (16). In addition, no washing column (23) was necessary to wash ammonium nitrate vapours from the steam disengaged from the container (16). Heat from the steam (22) disengaged from the container (16) was recovered in a heat exchanger (21).

1.-29. (canceled)

30. A jet ejector arrangement, comprising:
a jet ejector, comprising:
an internal nozzle having a base and a tip and, on a common longitudinal axis, an inlet for a motive fluid at the base and an outlet for an accelerated motive fluid at the tip;
a hollow tube having a base and surrounding the internal nozzle, such that the base of the hollow tube surrounds the base of the nozzle, and extending downstream the tip, wherein a flow direction in the hollow tube is defined by a flow direction of the motive fluid, for mixing and reacting the motive fluid with an additional fluid feed in a reaction zone in the hollow tube, thereby providing a reacted fluid; and
an opening in a wall of the hollow tube for entry of the additional fluid feed;
characterized in that the arrangement further comprises a feed line for the additional fluid, external to the jet ejector, wherein the feed line has an output end, which is not connected to the opening in the wall of the hollow tube, and wherein, when in operation, the jet ejector generates a suction zone outside the jet ejector via the opening, and wherein the output end of the feed line is located in said suction zone outside the jet ejector.

31. The jet ejector arrangement according to claim 30, further comprising flow control means in any one of the inlets for the motive fluid and the feed line.

32. The jet ejector arrangement according to claim 30, wherein the output end of the feed line is located from 1 to 15 cm away from the opening.

33. The jet ejector arrangement according to claim 30, comprising two openings diametrically opposed in the wall of the hollow tube.

34. A system for reacting at least two fluid chemicals with each other, comprising:
at least one jet ejector arrangement according to claim 30 and
a container;
wherein the at least one jet ejector arrangement is entirely located inside the container, the opening being in fluid communication with content of the container.

35. The system according to claim 34, comprising four jet ejector arrangements arranged inside the container, symmetrically with respect to each other and tangentially with respect to the wall of the container.

36. The system according to claim 35, wherein the jet ejectors arrangements are directed such that the flow direction in the jet ejectors is upwards and radially towards a center of the container.

37. The system according to claim 36, wherein the container has a volume ranging from 0.5 to 20 m³.

38. The system according to claim 34, comprising:
at least two of the jet ejector arrangements;
a recirculation line having an inlet in fluid communication with the content of the container, and an outlet in fluid communication with the content of the container; and
means for feeding part of the content of the container to the recirculation line.

39. The system according to claim 38, wherein the outlet of the recirculation line is in fluid communication with the inlet of the nozzle of a jet ejector, the flow direction in this jet ejector being upwards and tangential with respect to the wall of the container.

40. The system according to claim 38, further comprising temperature adjustment means in the recirculation line.

41. The system according to claim 34, the container comprising an outlet for its liquid content in a form of an overflow.

42. The system according to claim 34, further comprising means for recovering heat.

43. The system according to claim 34, further comprising means for separating out steam from the container and means for cleaning the separated steam.

44. A method for reacting two fluids in the system according to claim 34, comprising steps of:
a) feeding a first fluid as the motive fluid to the nozzle of at least one jet ejector arrangement; and
b) feeding a second fluid through the feed line of the at least one jet ejector arrangement, thereby reacting the two fluids.

45. The method according to claim 44, wherein the flows of the first fluid and of the second fluid are adjusted such that the first fluid and the second fluid reside in the hollow tube of the jet ejector for a period ranging from 0.1 to 5 seconds.

46. The method according to claim 44, wherein the fluid fed in step a) is a gas.

47. The method according to claim 44, further comprising the step of:
c) recirculating the content of the container back to the container.

48. The method according to claim 47, wherein the system comprises at least two jet ejectors, wherein, in step c), the content of the container is recirculated to the inlet of the nozzle of the at least second jet ejector.

49. The method according to claim 44, further comprising the step of:
d) operating flow control means in the inlet for the motive fluid and in the feed line of the at least one jet ejector arrangement, such as to control a ratio of the flow of the motive fluid over the flow in the feed line.

50. The method according to claim 44, wherein the nozzle of the at least one jet ejector arrangement is operated at atmospheric pressure.

51. The method according to claim 44, further comprising the step of:
e) adjusting a temperature of the content being recirculated during step c).

52. The method according to claim 44, wherein the fluid fed as the motive fluid in step a) is gaseous ammonia and wherein the fluid fed in step b) is nitric acid, such that the method produces ammonium nitrate.

53. The method according to claim 52, further comprising the step of:
f) recovering heat generated by a combination of steps a) and b).

54. The method according to claim 52, wherein, the motive fluid in step a) is ammonia gas, at a temperature ranging from 50 to 200° C. and a pressure ranging from 1.5 to 13 bar, and wherein, in step b), from 53 weight % to 63 weight % nitric acid is fed, at a temperature ranging from 20 to 100° C. and a pressure ranging from 1.5 to 3 bar.

55. The method according to claim 44, performed in a batch manner or continuously.

56. The method according to claim 44, wherein the first fluid is a base and the second fluid is an acid.

57. A method for designing a jet ejector arrangement, comprising steps of:
providing a jet ejector having an elongated body, comprising:
an internal nozzle having a base and a tip and, on a common longitudinal axis, an inlet for a motive fluid at the base and an outlet for the motive fluid at the tip;
a hollow tube having a base and surrounding the internal nozzle and extending downstream the tip (5), wherein a flow direction in the hollow tube is defined by a flow direction of the motive fluid, for mixing and reacting the motive fluid with an additional fluid feed in a reaction zone in the hollow tube, thereby providing a reacted fluid;
an opening in a wall of the hollow tube for entry of the additional fluid feed; and
a diffusor downstream the hollow tube, wherein the flow direction is aligned with the flow direction in the hollow tube, downstream the reaction zone, for expanding the reacted fluid, thereby producing an expanded reacted fluid;
providing a feed line having an output end, external to the jet ejector, wherein the output end is not connected to the opening in the wall of the hollow tube, but is freely located in a vicinity of the opening; and
modeling the location and dimensions of the opening for entry of the additional fluid feed using a computational fluid dynamic modeling tool.
